(19) United States
(12) Patent Application Publication
(10) Pub. No.: US 2010/0319065 A1
(43) Pub. Date: Dec. 16, 2010

(54) Firewall Configuration In A Base Station

(75) Inventor: Elisabeth Hansson, Linkoping (SE)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 12/746,703

(22) PCT Filed: Dec. 6, 2007
(86) PCT No.: PCT/SE2007/050947

§ 371 Date: Aug. 11, 2010

(51) Int. Cl. G06F 21/00

(52) U.S. Cl. 726/14

(57) ABSTRACT

The invention is directed towards methods of configuring a firewall in a first base station (12) in a wireless wide area network (CN, RAN) as well as to a firewall configuring device (20) and a first base station (12). The first base station (12) obtains new neighbour base station data related to updating of a neighbour list of this first base station (12), which data includes data identifying a second base station (14) provided in the neighbourhood of the first base station. Based on the data the firewall configuring device (20) provides the first base station (12) with firewall configuration data including a second authentic logical address of the second base station (14), which authentic address is not provided in the neighbour list before the updating. The first base station (12) uses the firewall configuring data for updating its firewall in order to allow communication with the second base station (14).

### TECHNICAL FIELD OF THE INVENTION

The present invention relates to the field of wireless wide area networks. The invention more particularly relates to methods of configuring a firewall in a first base station in a wireless wide area network as well as to a firewall configuring device and a first base station.

### DESCRIPTION OF RELATED ART

In a typical wireless wide area network, such as an LTE (Long Term Evolution) network, mobile stations communicate via a radio access network to one or more core networks. The mobile stations can be such stations as mobile telephones (“cellular” telephones) and laptops with mobile termination, and thus can be, for example, portable, pocket, hand-held, computer-included, or car-mounted mobile devices which communicate voice and/or data with radio access networks.

The radio access network covers a geographical area which is divided into cell areas, with each cell area being served by a base station, also denoted eNodeB in LTE. A cell is a geographical area where radio coverage is provided by the radio base station equipment at a base station site. Each cell is identified by a unique identity, a global cell identifier. The base stations communicate over an air interface (e.g., radio frequencies) with the mobile stations within range of the base stations.

The various fixed entities of a network such as base stations, support systems etc. in many such systems communicate with each other via a communication network using logical addresses of the communication network, which may be so called IP-addresses. This is a different type of identifier than the above mentioned identifier of a cell. In order to provide security in such communication each base station is furthermore provided with a firewall including rules that are applied for the communication.

The base stations in LTE will include a firewall that performs data packet filtering in order to restrict access to network resources. A packet filtering firewall blocks data packets based on their header fields such as source IP address, destination IP address and ports. Both incoming traffic and outgoing traffic is filtered by the firewall in the base station.

However, packet filtering requires the ability to classify packets according to specified filter rules. Normally, an administrator of the wireless wide area network specifies filtering rules such as accepted network addresses, IP addresses, and ports manually. An alternative is to distribute the filtering rules from a central server. This is easily performed if all nodes can use the same filtering rules. However, LTE networks may consist of hundreds of base stations with different filtering rules. A base station typically has contact with a few nodes in a core network and OSS (Operational Support System), but also with a few neighbour base stations. Different base stations have contact with different neighbour base stations. Thus, different base stations have different filter rules. In addition, a base station must also be able to communicate with a newly added neighbour base station. However it is no simple matter to change firewall configurations for allowing additions of base stations in a wireless wide area network that includes a great number of base stations.

There is therefore a need for an improved updating of firewalls provided in base stations.

### SUMMARY OF THE INVENTION

The present invention is therefore directed towards improving the updating of firewalls in a wireless wide area network.

One object of the present invention is thus to provide a method of configuring a firewall in a first base station in a wireless wide area network.

This object is according to a first aspect of the present invention achieved through a method of configuring a firewall in a first base station in a wireless wide area network, the first base station having a first logical address and comprising the steps of:

obtaining new neighbour base station data related to the updating of a neighbour list of the first base station in a firewall updating device in a support system of the wireless wide area network, and
providing, by the firewall updating device, the first base station with firewall configuration data in a secure way based on the new neighbour base station data, the firewall configuration data including a second authentic logical address of a second base station provided in the neighbourhood of the first base station, the second authentic logical address not being provided in the neighbour list of the first base station before the updating and the providing of firewall configuration data being performed in order to allow communication to be performed with the second base station.

Another object of the present invention is to provide a firewall configuring device in a wireless wide area network that improves firewall updating in base stations.

This object is according to a second aspect of the present invention achieved through a firewall configuring device in a support system of a wireless wide area network for configuring a firewall in a first base station in the wireless wide area network, the first base station having a first logical address, the device comprising:

a control unit configured to
obtain new neighbour base station data related to the updating of a neighbour list of the first base station, and
provide the first base station with firewall configuration data in a secure way based on the new neighbour base station data, the firewall configuration data including a second logical address of a second base station provided in the neighbourhood of the first base station, the second authentic logical address not being provided in the neighbour list of the first base station before the updating and the providing of firewall configuration data being performed in order to allow communication to be performed with the second base station.

Another object of the present invention is to provide a further method of configuring a firewall in a first base station in a wireless wide area network.

This object is according to a third aspect of the present invention achieved through a method of configuring a firewall in a first base station in a wireless wide area network, the first base station having a first logical address and comprising the steps of:

obtaining, in the first base station, new neighbour base station data related to the updating of a neighbour list of the first base station and including data identifying a second base station provided in the neighbourhood of the first base station,
providing a firewall configuring device in a support system of the wireless wide area network with the neighbour base station data in a secure way,
receiving firewall configuration data including a second authentic logical address of the second base station from the firewall configuring device in a secure way and being obtained based on the new neighbour base station data, the second authentic logical address not being provided in the neighbour list of the first base station before the updating, in order to allow communication to be performed with the second base station, and
updating a firewall of the first base station with the firewall configuration data.

Another object of the present invention is to provide a base station in a wireless wide area network that has improved firewall updating ability.

This object is according to a fourth aspect of the present invention achieved through a first base station in a wireless wide area network having a first logical address and comprising

a firewall allowing network access according to safety rules,
a firewall updating unit for updating the firewall,
a first network interface for communicating with a firewall configuring device in a support system of the wireless wide area network,
a second wireless interface for communicating with mobile stations in the wireless wide area network, and
a control unit configured to
obtain new neighbour base station data related to the updating of a neighbour list of the first base station and including data identifying a second base station provided in the neighbourhood of the first base station,
provide the firewall configuring device with the neighbour base station data in a secure way,
receive firewall configuration data including a second authentic logical address of the second base station from the firewall configuring device in a secure way and being obtained based on the new neighbour base station data, the second authentic logical address not being provided in the neighbour list of the first base station before the updating, in order to allow communication to be performed with the second base station, and
provide the firewall configuration data to the firewall configuring unit in order to update the firewall.

The present invention has the advantage of allowing firewall settings to be updated automatically in base stations. In this way manual updating is avoided. This is advantageous in wireless wide area networks including several base stations. The firewall updating is furthermore performed in a secure manner.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The present invention will now be described in more detail in relation to the enclosed drawings, in which:

FIG. 1 schematically shows a few elements of a wireless wide area network being interconnected,

FIG. 2 shows a block schematic of a first base station according to the present invention being connected to a mobile station,

FIG. 3 shows a block schematic of a firewall configuring device according to the present invention,

FIG. 4 shows a flow chart of a number of method steps taken in a method of configuring a firewall being performed in the first base station according to the present invention, and

FIG. 5 shows a flow chart of a number of method steps performed in a method of configuring a firewall in the first base station according to the present invention being performed in the firewall configuring device.

### DETAILED DESCRIPTION OF EMBODIMENTS

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. In other instances, detailed descriptions of well known devices, circuits, and methods are omitted so as not to obscure the description of the present invention with unnecessary details.

The present invention is directed towards dynamically changing firewall settings because of changes in a wireless wide area network.

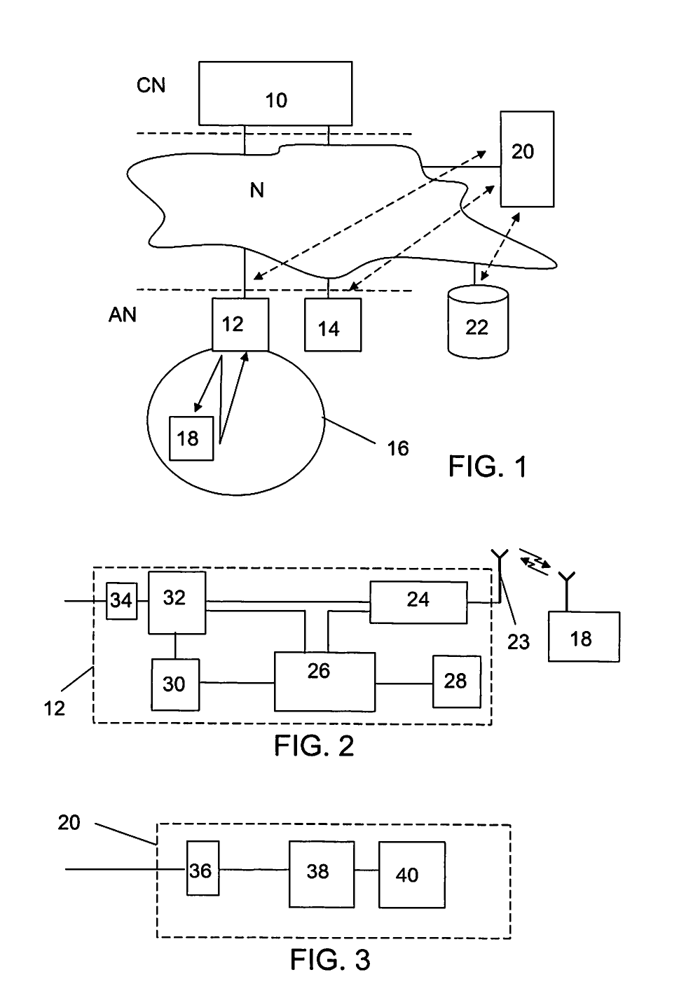

The present invention will now be described in more detail in the non-limiting example context of a wireless wide area network that is here a cellular network in the form of an LTE (Long Term Evolution) network shown in FIG. 1. An LTE network is just one example of a wireless wide area network where the present invention may be implemented. It may for example be provided in other types of networks like for instance in a WiMAX network. The LTE network includes a core network section CN and a radio access network section RAN. The core network section CN has a node 10 providing communication with various other networks, such as such as PSTN (Public Switched Telephone Network) or GSM (Global System for Mobile communication). The node 10 may also provide communication with connectionless-oriented networks such as the Internet.

The core network node 10 connects to the radio access network section RAN via a communication network N, which communication network N is a packet-oriented communication network, such as a computer communication network like the Internet or an Intranet. The radio access network section RAN includes a number of base stations, where two 12 and 14 are shown in FIG. 1. Each of these base stations 12 and 14 control communication within a cell. Here it should be realised that one base station may handle more than one cell. In the figure only one cell 16 associated with the first base station 12 is shown. The cells are provided in a geographical area covered by the radio access network section RAN. In FIG. 1 a mobile station 18 is shown in the cell 16 and communicating with the first base station 12. It should be realised that normally there may be provided several mobile stations communicating with a base station.

In FIG. 1 there is also shown a firewall configuring device 20, with which the two base stations 12 and 14 are communicating. They are here communicating with the firewall configuring device 20 also via the communication network N, which may be the Internet or an Intranet. The communication between the base stations 12 and 14 and the firewall configuring device may be secure using secure protocols such as SSH (Secure Shell), TLS (Transport Layer Security) and SFTP (SSH File Transfer Protocol). The communication network N is here preferably a computer communication network. The firewall configuring device 20 may be provided as a part of an OSS (Operational Support System) system provided by the network operator of the wireless wide area network. The firewall configuring device 20 is furthermore communicating with a DNS (domain name server) server 22. This domain name server 22 is here shown as an external server, i.e. a server which is not a part of the wireless wide area network. However, it should be realized that as an alternative the server 22 may be provided as a part of the wireless wide area network and then as a part of the OSS system. The communication is in FIG. 1 indicated by dashed arrows.

FIG. 2 shows a block schematic of the first base station 12. The first base station 12 includes a first network interface 34 for communicating over the communication network. This first network interface 34 is connected to a firewall 32, which in turn is connected to a firewall updating unit 30, to a first control unit 26 and to a radio circuit 24. The first control unit 26 is furthermore also connected to the firewall updating unit 30, the radio circuit 24 and to a first neighbour list store 28. The radio circuit 24 is furthermore connected to an antenna 23 for communicating wirelessly with the mobile station 18. The radio circuit 24 and antenna 23 thus here make up a second wireless interface for communicating with mobile stations. The first neighbour list store 28 here includes a neighbour list. This list includes data about neighbouring base stations, i.e. base stations located in the vicinity or neighbourhood of the first base station 12 and with which the first base station 12 may communicate. For each such neighbour base station there is stored a wireless wide area network identifier, here a global cell identifier, through which a base station is identified by mobile stations in the access network and an associated logical address associated with the computer communication network, here an IP address. However, it does not include any entries for the second base station, which will be described in more detail later on. The first base station 12 also has an own logical address, here termed a first logical address.

FIG. 3 shows a block schematic of the firewall configuring device 20. The firewall configuring device 20 also includes a third network interface 36 for communicating over the computer network. This third network interface 36 is connected to a second control unit 38. The second control unit 38 is finally connected to a second neighbour list store 40.

The base stations communicate with other entities in and outside of the wireless wide area network via the communication network N. For this reason they are each provided with logical addresses. However in order to provide security of the wireless wide area network, each such base station includes a packet filtering firewall in order to restrict access to network resources. A packet filtering firewall may for instance block packets based on their header fields. The blocking can then be made based on data such as logical addresses, for instance source IP address, destination IP address as well as on ports. Both incoming traffic and outgoing traffic is then filtered by the firewall in a base station in order to restrict communication to entities in the wireless wide area network that have authentic logical addresses.

However, packet filtering requires the ability to classify packets according to specified filter rules. Normally, an administrator of the wireless wide area network specifies filtering rules such as accepted network addresses, IP addresses and ports manually. An alternative is to distribute the filtering rules from a central server, for instance from a server in the OSS. This is easily performed if all nodes can use the same filtering rules. However, wireless wide area networks may consist of hundreds of base stations with different filtering rules. A base station typically has contact with a few nodes in the Core Network section CN and OSS, but also with a few neighbour base stations. Different base stations have contact with different neighbour base station. Thus, different base stations have different filter rules. In addition, a base station must also be able to communicate with newly added neighbour base stations. Thus, the filter rules need to be changed dynamically.

A firewall in a base station here has a basic configuration including packet filtering rules for communicating with the Core Network and OSS. According to the present invention these filter rules are automatically configured in a secure way for new base stations or base stations, the logical addresses of which are being changed. This is done in order to enable communication between base stations, which may be performed over a so-called X2 interface.

In the wireless wide area network each base station may furthermore have one or more identifiers associated with the wireless wide area network. In the case of LTE these are cell identifiers, i.e. an identity associated with a cell of the cellular network. Such a cell identifier is here a global cell identifier. Each base station is provided with one such global cell identifier for each cell it is to cover. This is the identity of a base station that mobile stations know and may use in communication with a base station. However if base stations are to communicate with each other and other entities in the access or core network, they cannot use this identity, they use the logical address of the base station, which logical address is associated with the computer communication network. In order to enable communication, for instance in relation to handover, each base station includes a neighbour list in its neighbour list store. In such a store there is therefore an association between the global cell identifiers and the logical address of each neighbouring base station. Such mapping may be done beforehand and may be made manually or automatically for each base station. Since the base stations are spread out over a geographical area no neighbour list is furthermore identical from base station to base station. Hence there are a great number of various neighbour lists in a wireless wide area network. The OSS system does also have the neighbour lists of the base stations in the wireless wide area network. These lists are here provided in the second neighbour list store of the firewall configuring device.

The firewall of a base station does furthermore also need to include authentic logical addresses of neighbour base stations in the neighbour list in order to allow communication between these base stations. This inclusion may in many cases be provided beforehand as the wireless wide area network is being set up. However, in case changes are being made, like a new base station being added, an old base station receiving a new logical address or a base station being deleted from a neighbour list, the settings in both the neighbour list and the firewall are not correct, which leads to communication not being possible between base stations where one is new or has its logical address changed.

The present invention is directed towards solving this problem.

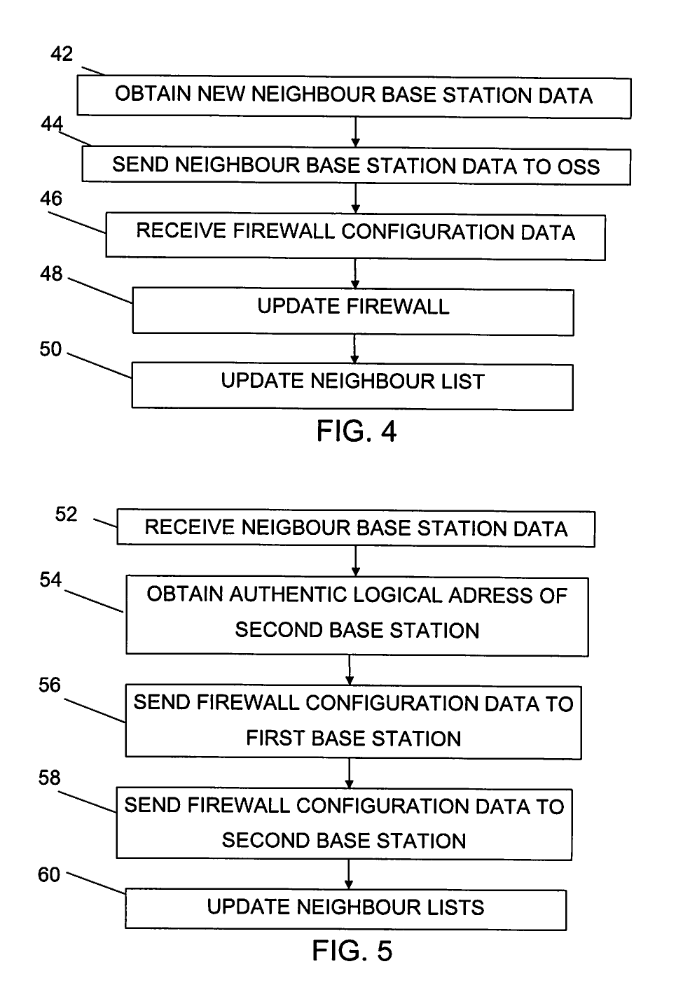

Therefore the present invention will now be described with reference being made to the previously mentioned FIG. 1-3, as well as to FIG. 4, which shows a flow chart of a number of method steps taken in a method of configuring a firewall being performed in the first base station, and to FIG. 5, which shows a flow chart of a number of method steps taken in a method of configuring a firewall in the first base station being performed in the firewall configuring device.

One situation which may give rise to an updating of the firewall of the first base station 12 is when a mobile station, here mobile station 18, is to be handed over from one source base station to another target base station, here from the first base station 12 to the second base station 14, when the target base station is not included in the neighbour list in the first neighbour list store 28. The mobile station 18 may then indicate that it wants to be handed over to the second base station 14. Then, the first base station 12 checks if it has the target cell in the neighbour list. If the source base station, i.e. the first base station 12, does not have the target cell in the neighbour list, the mobile station 18 will signal the global cell identifier of the cell associated with the second base station 14 to the first base station 12. However, the first base station 12 does not have a logical address, i.e. an IP address, to the second base station 14 since it has not previously communicated with the second base station 14. Therefore the second base station 14 is provided in the neighbourhood of the first base station 12 but not included in the neighbour list in the first neighbour list store 28. It therefore adds the new base station to the neighbour list. It thus updates the neighbour list with the second base station.

The method of the present invention may thus start with the first base station 12 obtaining new neighbour base station data, which is data concerning the second base station 14, step 42. In this example the new neighbour base station data is the above mentioned global cell identifier of the second base station 14, which is received from the mobile station 18 by the first control unit 26 via the radio communication unit 24 and antenna 23. As mentioned above this identifier may be received in relation to a handover. However it may also be received in relation to a tracing of the mobile station 18 or because of some other reason. Then the control unit 26 checks if it has data concerning the second base station in its neighbour list in the first neighbour list store 28 and since it does not it proceeds and sends the neighbour base station data to the firewall configuring device 20 of the OSS system in a secure way via the first network interface 34, step 54. This secure way may be through a secure connection or a secure communication session. In the present example the neighbour base station data only includes the above mentioned global cell identifier. The firewall 32 does furthermore include rules that allow communication to be made with the firewall configuring device 20, which guarantees that said neighbour base station data reaches the firewall configuring device 20.

The second control unit 38 of the firewall configuring device 20 then receives the neighbour base station data via the network interface 36, step 52. Thereafter it obtains the authentic logical address of the target base station, step 54. One way of obtaining the authentic logical address is to connect to the DNS server 22 via a secure connection or via a secure communication session. Through these measures, the DNS server 22 is considered to be trusted. The second control unit 38 may then send a name of the second base station 14, which name may have been located through investigating a table listing the names of base stations for the corresponding global cell identifiers. As a response it then receives the authentic logical address, i.e. the IP address, of the second base station 14 from the DNS server 22. In case the DNS server 22 is a part of the OSS system, it is also possible that the authentic IP address is obtained directly based on the global cell identifier. As this has been done the firewall configuring device 20 may investigate its own neighbour list store 40 and locate the neighbour list for the first base station 12. In case the second base station 14 is not included in the list, it knows that also the firewall of the first base station 12 is not configured for communication with the second base station 14. It therefore decides that the firewalls of both these base stations 12 and 14 need updating, since there is a change in the neighbour base stations of the first base station 12. It therefore sends firewall configuring data to the first base station 12 in a secure way via the network interface 36, step 56, which data includes the authentic logical address of the second base station 14. It furthermore also sends firewall configuring data in a secure way to the second base station 14, step 58, which data then includes the authentic logical address of the first base station 12. This secure way may also here be through a secure connection or a secure communication session.

The first control unit 26 of the first base station 12 receives this firewall configuring data via the network interface 34, step 46. Said data is then forwarded to the firewall updating unit 30. The firewall updating unit 30 thereafter updates the rules of the firewall 32 so that communication is also allowed with the second base station 14, step 48. Thereafter the neighbour list in the first neighbour list store 28 may be updated, step 50. This updating may be made as soon as the authentic address is obtained. It may also be updated based on an order to update the list which is sent from the firewall configuring device 20, step 60. The firewall configuring device 20 may here also update the neighbour lists for both the first and the second base stations in its own neighbour list store 40 as well as order them both to update their neighbour lists.

Updating of a firewall is therefore made automatically in relation to an updating of a neighbour list of the first base station. It is triggered by the updating of the neighbour list. In the example given above the neighbour list in the first neighbour list store was updated after the updating of the rules in the firewall. However, it should be realised that it may be updated at any time after data concerning a new neighbour base station is received in the first base station. It may thus be updated before an authentic logical address is received.

It is possible that the first base station itself locates a logical address of the second base station through querying a DNS server. However, it does in this case not know if it is authentic or not, since it normally does not have a secure connection with the DNS server. In this case it may update the neighbour list with the logical address received from the DNS server. The neighbour base station data sent to the firewall configuring device may in this case also include this logical address, which is then verified by the firewall configuring device. Therefore the first base station may here translate the global cell identifier to a DNS name by querying a server in the OSS. Then, the first base station may perform a DNS look up in a DNS server in order to receive the logical address of the second base station. As an alternative the first base station may only send the global cell identifier to a server, which may perform the above mentioned translation of the global cell identifier to a DNS name and thereafter perform DNS lookup. As yet another alternative it is possible that the above mentioned OSS server translates directly from the cell identifier to the logical address.

A change of a logical address may take place after a cold start of a base station. If this happens for a neighbour base station that the first base station intends to communicate with, it would be notified by the communication network that a certain logical address used in a packet is not longer working. The first control unit in the first base station will then notice this and request a new authentic logical address from the OSS. Thereafter, configuration of the firewall follows. The new base station data does in this case include a request concerning the correct logical address of a neighbour base station.

As an alternative to the firewall configuring device sending a query to a DNS server, it is possible that it instead queries the second base station directly via a secure connection or secure channel, such as SSH (Secure Shell) or TLS (Transport Layer Security)).

As yet another alternative it is possible that each base station in the wireless wide area network reports its own logical address to the firewall configuring device via a secure connection each time it receives a new logical address. Thus in this case the firewall configuring device receives neighbour base station data in the form of an authentic logical address directly from a base station. A newly added base station or a base station receiving a new logical address may thus always send its new authentic logical address through a secure channel to the OSS.

It is furthermore possible that the firewall configuring device performs an update each time it receives an updated neighbour list or each time that a neighbour list is updated centrally in the OSS system. The neighbour base station data sent from a base station may thus also be in the form of an updated neighbour list. A central updating of neighbour lists may be made by the OSS system because of inference problems, where new base stations are added to a neighbour list.

A firewall may be configured every time a neighbour list is changed or to be changed if
a new cell that is added to a neighbour list is not handled by a target base station which is currently permitted to communicate with the source base station and vice versa.
a removed cell from the neighbour list is handled by a target base station that no longer has any cell included in the neighbour list.
a base station in a neighbour list changes logical address

When a base station is deleted from a neighbour list, then the firewall configuring data includes an instruction to delete the logical address of this base station from the firewall settings.

Since firewall settings are updated automatically, manual updating is avoided. This is advantageous in wireless wide area networks including several base stations. The firewall updating is furthermore performed in a secure manner, which is also advantageous.

The control unit and firewall updating unit of the first base station as well as the control unit of the firewall configuring device according to the present invention can be implemented through one or more processors together with computer program code for performing their functions. The program code mentioned above may also be provided as a computer program product, for instance in the form of a data carrier carrying computer program code for performing the method according to the present invention when being loaded into a computer.

While the invention has been described in connection with what is presently considered to be most practical and preferred embodiments, it is to be understood that the invention is not to be limited to the disclosed embodiments, but on the contrary, is intended to cover various modifications and equivalent arrangements. Therefore the present invention is only to be limited by the following claims.

1. The method of configuring a firewall in a first base station in a wireless wide area network, said first base station having a first logical address and said firewall having filtering rules for the base station, the method comprising the steps of:
obtaining new neighbour base station data related to the updating of a neighbour list of said first base station in a firewall updating device in a support system of the wireless wide area network; and
providing, by the firewall updating device, the first base station with firewall configuration data in a secure way based on the new neighbour base station data, said firewall configuration data including a second authentic logical address of a second base station provided in the neighbourhood of the first base station, said second authentic logical address not being provided in the neighbour list of the first base station before said updating and said providing of firewall configuration data being performed in order to allow communication to be performed with the second base station.

2. The method according to claim 1, wherein the first logical address is missing in a second neighbour list of the second base station and further comprising the step of providing the second base station with firewall configuration data including a first authentic logical address of the first base station in order to allow communication to be performed with the first base station.

3. The method according to claim 1, wherein the step of obtaining new neighbour base station data includes sending a query about the logical address of the second base station via a secure connection and receiving said second authentic logical address as a response to the query.

4. The method according to claim 3, wherein the query is sent to the second base station.

5. The method according to claim 1, wherein the step of obtaining new neighbour base station data includes receiving said second authentic logical address of the second neighbour base station directly from said second base station.

6. The method according to claim 3, wherein the query is sent to a trusted address providing server.

7. The method according to claim 3, wherein the step of obtaining new neighbour base station data includes receiving a query regarding the second base station from the first base station.

8. The method according to claim 7, wherein the received query includes at least one wireless wide area network identifier associated with said second neighbouring base station from said first base station.

9. The method according to claim 7, wherein the received query includes a logical address of the second base station and the step of sending a query being performed in order to verify that said received logical address is said second authentic logical address.

10. The method according to claim 7, wherein the received query includes a request for the authentic logical address of the second base station.

11. The method according to claim 1, wherein the step of obtaining new neighbour base station data comprises receiving an updated neighbour list from the first base station including data identifying the second base station.

12. The method according to claim 1, further comprising the step of updating the neighbour list of the first base station, where the updated neighbour list includes the authentic logical address of the second base station.

13. The method according to claim 12, further comprising the step of updating the neighbour list of the second base station.

14. The method according to claim 1, wherein the step of obtaining new neighbour base station data comprises obtaining a centrally updated neighbour list of the first base station.

15. The method according to claim 1, wherein the step of providing the first base station with firewall configuration data is triggered by an updating of the neighbour list of the first base station.

16. A firewall configuring device in a support system of a wireless wide area network for configuring a firewall in a first base station in the wireless wide area network, said first base station having a first logical address and said firewall having filtering rules for the base station, said device comprising:
a control unit configured to obtain new neighbour base station data related to the updating of a neighbour list of said first base station, and
provide the first base station with firewall configuration data in a secure way based on the new neighbour base station data, said firewall configuration data including a second logical address of a second base station provided in the neighbourhood of the first base station, said second authentic logical address not being provided in the neighbour list of the first base station before said updating and said providing of firewall configuration data being performed in order to allow communication to be performed with the second base station.

17. A method of configuring a firewall in a first base station in a wireless wide area network, said first base station having a first logical address and said firewall having filtering rules for the base station, the method comprising the steps of:
obtaining, in the first base station, new neighbour base station data related to the updating of a neighbour list of said first base station and including data identifying a second base station provided in the neighbourhood of the first base station, providing a firewall configuring device in a support system of the wireless wide area network with said neighbour base station data in a secure way, receiving firewall configuration data including a second authentic logical address of the second base station from the firewall configuring device in a secure way and being obtained based on the new neighbour base station data, said second authentic logical address not being provided in the neighbour list of the first base station before said updating, in order to allow communication to be performed with the second base station, and
updating a firewall of the first base station with said firewall configuration data.

18. The method according to claim 17, wherein said base station data includes a wireless wide area network identifier associated with the second base station.

19. The method according to claim 17, wherein said new base station data includes a logical address of the second base station.

20. The method according to claim 19, further comprising the step of obtaining said logical address of the second base station from an address providing server.

21. The method according to any of claim 17, further comprising the step of updating the neighbour list of the first base station with said authentic second logical address.

22. A first base station in a wireless wide area network having a first logical address and comprising
a firewall allowing network access for the base station according to safety rules,
a firewall updating unit for updating said firewall,
a first network interface for communicating with a firewall configuring device in a support system of the wireless wide area network,
a second wireless interface for communicating with mobile stations in the wireless wide area network, and
a control unit configured to
obtain new neighbour base station data related to the updating of a neighbour list of said first base station and including data identifying a second base station
provided in the neighbourhood of the first base station, provide said firewall configuring device with said neighbour base station data in a secure way,
receive firewall configuration data including a second authentic logical address of the second base station from the firewall configuring device in a secure way and being obtained based on the new neighbour base station data, said second authentic logical address not being provided in the neighbour list of the first base station before said updating, in order to allow communication to be performed with the second base station, and
provide said firewall configuration data to said firewall configuring unit in order to update the firewall.
